(19) United States
(12) Patent Application Publication
(10) Pub. No.: US 2023/0138464 A1
(43) Pub. Date: May 4, 2023

(54) SYSTEM AND METHOD FOR IMPROVED PARKING SPACE DETECTION

(71) Applicant: Parkofon Inc., Vienna, VA (US)

(72) Inventors: Alexey Gribko, Dresden (DE); Elena Urman, Damascus, MD (US); Sahil Jindal, Amherst, MA (US)

(21) Appl. No.: 18/087,551

(22) Filed: Dec. 22, 2022

(51) Int. Cl. G06V 20/58; G06V 10/26; G06V 20/13

(52) U.S. Cl. CPC G06V 20/586; G06V 10/273; G06V 20/13

(57) ABSTRACT

Various implementations include a system and method for operating a parking space detection. A system may analyze an image tile for parking spaces. A method implemented by the system may include detecting a plurality of parking spaces from the image tile; analyzing the plurality of parking spaces for false parking spaces; removing at least one detected false parking space from the plurality of parking spaces to form a set of remaining plurality of parking spaces; and determining one or more parking space attributes of the remaining plurality of parking spaces. The method may also include storing the remaining plurality of parking spaces, the determined at least one obscured parking space, and their respective associated parking space attributes. The method may further include enabling at least one detected parking space of the plurality of parking spaces to be used to aid an activity associated with a vehicle.

### FIELD OF THE DISCLOSURE

Implementations of the disclosure relate to systems, servers, methods, and devices for computing, providing enhanced functionality and technical improvements over exiting computing systems for machine learning and object detection in the transportation industry.

### BACKGROUND

Satellite data and map data of cities and towns exist, which can be used to identify the location of some objects, like buildings. However, existing map data lacks details for smaller objects like parking spaces. Machine learning and artificial intelligence are used for object detection in images, however existing systems do not accurately detect small objects in map data or satellite images, such as parking spaces.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some aspects, the techniques described herein relate to a method of operating a parking space detection system including: analyzing an image tile for parking spaces; detecting a plurality of parking spaces from the image tile; analyzing the plurality of parking spaces for false parking spaces; removing at least one detected false parking space from the plurality of parking spaces to form a set of remaining plurality of parking spaces; analyzing the image tile for obscured parking spaces based on the remaining plurality of parking spaces; determining at least one obscured parking space based on the remaining plurality of parking spaces; determining one or more parking space attributes of the remaining plurality of parking spaces and one or more parking space attributes of the at least one obscured parking space based on attributes determined from at least some of the remaining plurality of parking spaces; storing the remaining plurality of parking spaces, the determined at least one obscured parking space, and their respective associated parking space attributes; and enabling at least one detected parking space of the plurality of parking spaces to be used to aid an activity associated with a vehicle.

In some aspects, the techniques described herein relate to the method, wherein the image tile includes a portion of a satellite image.

In some aspects, the techniques described herein relate to the method that further includes analyzing a plurality of image tiles for parking spaces.

In some aspects, the techniques described herein relate to the method, wherein an image tile of the plurality of image tiles includes a portion of a satellite image.

In some aspects, the techniques described herein relate to the method that further includes creating at least one synthetic image tile from at least two image tiles of the plurality of image tiles.

In some aspects, the techniques described herein relate to the method that further includes detecting at least one parking space from the at least one synthetic image tile.

In some aspects, the techniques described herein relate to the method, wherein at least a first portion of the detected at least one parking space from the at least one synthetic image tile was located on a first image tile of the at least two image tiles and at least a second portion of the detected at least one parking space from the at least one synthetic image tile was located on a second image tile of the at least two image tiles.

In some aspects, the techniques described herein relate to the method that further includes: removing any detected false parking spaces from the detected at least one parking space from the at least one synthetic image tile; determining one or more parking space attributes from the detected at least one parking space from the at least one synthetic image tile; analyzing the synthetic image tile for additional obscured parking spaces based on the remaining plurality of parking spaces and the detected at least one parking space from the at least one synthetic image tile; determining at least one additional obscured parking space based on the remaining plurality of parking spaces and the detected at least one parking space from the at least one synthetic image tile; determining one or more parking space attributes of the at least one additional obscured parking space based on attributes determined from at least some of the remaining plurality of parking spaces and the detected at least one parking space from the at least one synthetic image tile; storing the remaining plurality of parking spaces, the determined at least one obscured parking space, the detected at least one parking space from the at least one synthetic image tile, the determined at least one obscured parking space, and their respective associated parking space attributes.

In some aspects, the techniques described herein relate to the method, wherein the activity associated with the vehicle is a commercial transaction.

In some aspects, the techniques described herein relate to the method, wherein the activity associated with the vehicle is analyzing the vehicle's position for a geofencing system.

In some aspects, the techniques described herein relate to the method, wherein the activity associated with the vehicle is navigation.

In some aspects, the techniques described herein relate to the method, wherein the activity associated with the vehicle is parking.

In some aspects, the techniques described herein relate to the method that further includes obtaining one or more satellite images; creating a plurality of image tiles from the one or more satellite images; detecting a plurality of parking spaces from the plurality of image tiles.

In some aspects, the techniques described herein relate to the method, wherein the one or more parking space attributes include line color and type of parking space.

In some aspects, the techniques described herein relate to a device for operating a parking space detection including: one or more processors configured to: analyze an image tile for parking spaces; detect a plurality of parking spaces from the image tile; analyze the plurality of parking spaces for false parking spaces; remove at least one detected false parking space from the plurality of parking spaces to form a set of remaining plurality of parking spaces; determine one or more parking space attributes of the remaining plurality of parking spaces; analyze the image tile for obscured parking spaces based on the remaining plurality of parking spaces; determine at least one obscured parking space based on the remaining plurality of parking spaces; determine one or more parking space attributes of the at least one obscured parking space based on attributes determined from at least some of the remaining plurality of parking spaces; store the remaining plurality of parking spaces, the determined at least one obscured parking space, and their respective associated parking space attributes; and enable at least one detected parking space of the plurality of parking spaces to be used to aid an activity associated with a vehicle.

In some aspects, the techniques described herein relate to the device, wherein the image tile includes a portion of a satellite image.

In some aspects, the techniques described herein relate to the device, wherein the one or more processors are further configured to: analyze a plurality of image tiles for parking spaces.

In some aspects, the techniques described herein relate to the device, wherein an image tile of the plurality of image tiles includes a portion of a satellite image.

In some aspects, the techniques described herein relate to the device, wherein the one or more processors are further configured to: create at least one synthetic image tile from at least two image tiles of the plurality of image tiles.

In some aspects, the techniques described herein relate to the device, wherein the one or more processors are further configured to: detect at least one parking space from the at least one synthetic image tile.

In some aspects, the techniques described herein relate to the device, wherein at least a first portion of the detected at least one parking space from the at least one synthetic image tile was located on a first image tile of the at least two image tiles and at least a second portion of the detected at least one parking space from the at least one synthetic image tile was located on a second image tile of the at least two image tiles.

In some aspects, the techniques described herein relate to the device, wherein the one or more processors are further configured to: remove any detected false parking spaces from the detected at least one parking space from the at least one synthetic image tile; determine one or more parking space attributes from the detected at least one parking space from the at least one synthetic image tile; analyze the synthetic image tile for additional obscured parking spaces based on the remaining plurality of parking spaces and the detected at least one parking space from the at least one synthetic image tile; determine at least one additional obscured parking space based on the remaining plurality of parking spaces and the detected at least one parking space from the at least one synthetic image tile; determine one or more parking space attributes of the at least one additional obscured parking space based on attributes determined from at least some of the remaining plurality of parking spaces and the detected at least one parking space from the at least one synthetic image tile; and store the remaining plurality of parking spaces, the determined at least one obscured parking space, the detected at least one parking space from the at least one synthetic image tile, the determined at least one obscured parking space, and their respective associated parking space attributes.

In some aspects, the techniques described herein relate to the device, wherein the one or more processors are further configured to: enable at least one detected parking space of the plurality of parking spaces to be used to aid an activity associated with a vehicle, wherein the activity associated with the vehicle is a commercial transaction.

In some aspects, the techniques described herein relate to the device, wherein the one or more processors are further configured to: enable at least one detected parking space of the plurality of parking spaces to be used to aid an activity associated with a vehicle, wherein the activity associated with the vehicle is analyzing the vehicle's position for a geofencing system.

In some aspects, the techniques described herein relate to the device, wherein the one or more processors are further configured to: enable at least one detected parking space of the plurality of parking spaces to be used to aid an activity associated with a vehicle, wherein the activity associated with the vehicle is navigation.

In some aspects, the techniques described herein relate to the device, wherein the one or more processors are further configured to: enable at least one detected parking space of the plurality of parking spaces to be used to aid an activity associated with a vehicle, wherein the activity associated with the vehicle is parking.

In some aspects, the techniques described herein relate to the device, wherein the one or more processors are further configured to: obtain one or more satellite images; create a plurality of image tiles from the one or more satellite images; and detect a plurality of parking spaces from the plurality of image tiles.

In some aspects, the techniques described herein relate to the device, wherein the one or more processors, when the one or more parking space attributes, are configured to line color and type of parking space.

In some aspects, the techniques described herein relate to a method of operating a parking space detection system including: analyzing one or more image tiles for parking spaces; detecting a plurality of parking spaces from the one or more image tiles; analyzing the plurality of parking spaces for false parking spaces; removing detected false parking spaces from the plurality of parking spaces, forming a set of remaining plurality of parking spaces; determining one or more parking space attributes of the remaining plurality of parking spaces; analyzing the image tile for obscured parking spaces based on the remaining plurality of parking spaces; determining at least one obscured parking space based on the remaining plurality of parking spaces; determining one or more parking space attributes of the at least one obscured parking space based on attributes determined from at least some of the remaining plurality of parking spaces; storing the remaining plurality of parking spaces, the determined at least one obscured parking space, and their respective associated parking space attributes; and using the detected parking spaces to aid an activity associated with a vehicle.

### BRIEF DESCRIPTION OF THE DRAWINGS

FIG. 1 illustrates a parking space detection system, according to some implementations of the present disclosure.

FIG. 2 is a block diagram illustrating a parking space detection server, according to some implementations of the present disclosure.

FIG. 3 is a flowchart of an example process of training a parking space detection system, according to some implementations of the present disclosure.

FIG. 4A is a flowchart of an example process of detecting parking spaces and various features/attributes of parking spaces, according to some implementations of the present disclosure.

FIG. 4B is a flowchart of an example process of image preprocessing and determining one or more features/attributes based on the image preprocessing, according to some implementations of the present disclosure.

FIG. 5 is an illustration of an image tile creation process that can be used in connection with some systems and methods, according to some implementations of the present disclosure.

FIG. 6A, FIG. 6B, FIG. 6C, and FIG. 6D are illustrations of creating a synthesized image tile that can be used in connection with some systems and methods, according to some implementations of the present disclosure.

FIG. 7 is an illustration of a parking space detection method that can be used in connection with some systems and methods, according to some implementations of the present disclosure.

FIG. 8 is an illustration of image preprocessing of parking spaces that can be used in connection with some systems and methods, according to some implementations of the present disclosure.

FIG. 9 is a flowchart of an example process of creating synthesized image tiles from image tiles, according to some implementations of the present disclosure.

### DETAILED DESCRIPTION

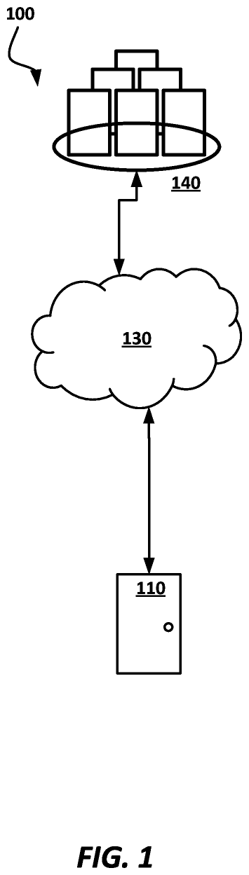

FIG. 1 illustrates a parking space detection system, according to some implementations of the present disclosure. In some implementations, parking space detection system 100 may include an end user device 110, a network 130, and a parking space detection server 140.

In some implementations, the end user device 110 may comprise a stand-alone computing device. By way of non-limiting example, an end user device 110 may comprise one or more of a server, a desktop computer, a laptop computer, a handheld computer, a tablet computing platform, a netbook, a smartphone, an in-vehicle computer (e.g., an in-vehicle infotainment “IVI” system), and/or other computing devices or platforms. In some implementations, the end user device 110 can be used to receive user inputs and commands that can be communicated to the parking space detection server 140. For example, an end user device 110 can be used by a user to interface with the parking space detection server 140 to configure the parking space detection server 140 to train one or more machine learning models on training images. In some implementations, the end user device 110 can be used by a user to obtain images to detect parking spaces that are provided to parking space detection server 140 for processing. In some implementations, the end user device 110 can be an IVI that requests information regarding one or more detected parking spaces from the parking space detection server 140. An end user device 110 may include, but is not limited to, user interface devices such as computer monitors, touch screens, buttons, keyboards, etc. An end user device 110 may include one or more processors, one or more types of non-transitory memory devices (e.g., RAM, ROM, etc.), network interface devices, etc. In some implementations, the parking space detection system 100 may include one or more end user devices 110. In some implementations, the end user device 110 is in direct or indirect communication with the parking space detection server 140. In some implementations, the end user device 110 is in communication with the parking space detection server 140 via network 130.

In some implementations, the end user device 110 may include one or more geographical information system (GIS) modules. In some implementations, a user of end user device 110 may use a GIS module to tag (e.g., mark) or define one or more objects in images, such as satellite images. In some implementations, a user of the end user device 110 may tag objects such as parking spaces in one or more images using a GIS module. In some implementations, a user of end user device 110 may also tag or define features/attributes of the tagged parking spaces using a GIS module. For example, the features of a tagged parking space may include, but are not limited to, line color, surface type, line style, shape, and painted color. In some implementations, the tagged objects, such as parking spaces in images can be used to train machine learning (ML) or artificial intelligence (AI) systems to find and tag/mark/define similar objects and features associated with the objects. In some implementations, the images tagged using the GIS module can be transmitted to parking space detection server 140 to train ML or AI systems stored in the parking space detection server 140. It should also be appreciated that in some implementations, the GIS module can be stored and run from parking space detection server 140 or some other suitable device or system.

In some implementations, the parking space detection system 100 includes at least one network such as network 130, which can be used to communicate between one or more devices or nodes in the parking space detection system 100. In some implementations, the devices or nodes in the parking space detection system 100 may include, but are not limited to, the end user device 110 and the parking space detection server 140. In some implementations, network 130 is a wide area network (WAN). In some implementations, network 130 is a plurality of WANs. In some implementations, the network 130 is one or more local area networks (LAN). In some implementations, network 130 is a combination of one or more LAN networks and one or more WAN networks. In some implementations, the LAN and/or WAN networks are hardwired networks (e.g., Ethernet™, fiber optic, etc.). In some implementations, one or more LAN and/or WAN networks can be a suitable wireless network (e.g., cellular, WiFi™ Bluetooth™, satellite, etc.). In some implementations, one or more LAN and/or WAN networks can be a combination of hardwired and wireless networks. For example, the parking space detection server 140 may communicate with the end user device 110 through one or more network devices (e.g., routers, switches, etc.) in one or more LAN environments, one or more WAN environments, or some combination of the foregoing. In some implementations, for example, where the parking space detection server 140 is located within a certain proximity to the end user device 110 (e.g., within a distance suitable for LAN communications), the two devices may communicate over one or more LANs. In some implementations, where the parking space detection server 140 is not physically located within a certain proximity where the end user device 110 is located, the two devices may communicate over one or more WANs (e.g., the Internet and/or private networks). It should be appreciated that any suitable network environment or combination of network environments can be used for communication between various devices or nodes in the parking space detection system 100.

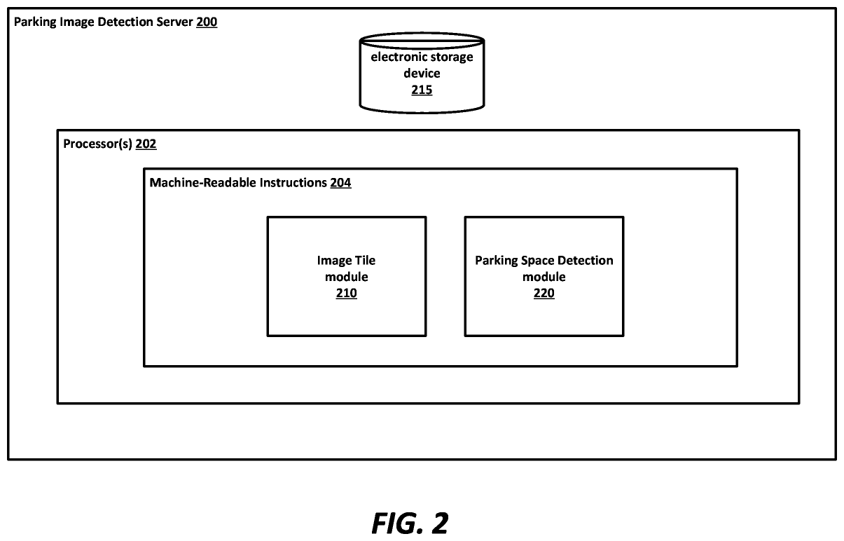

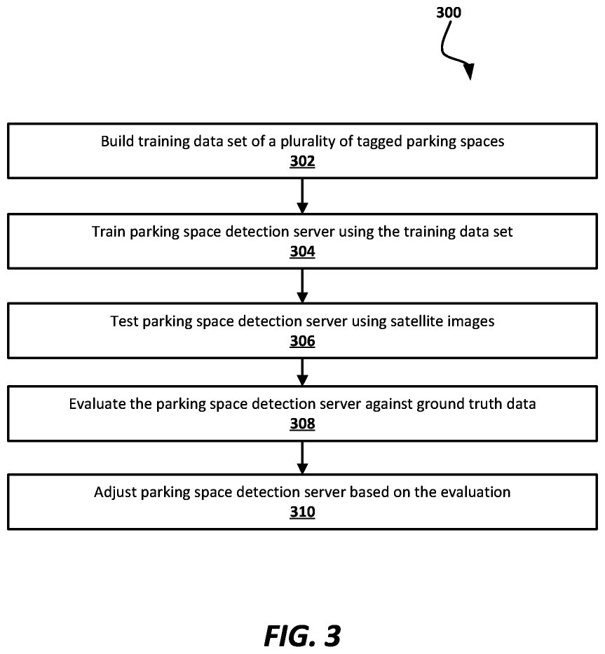

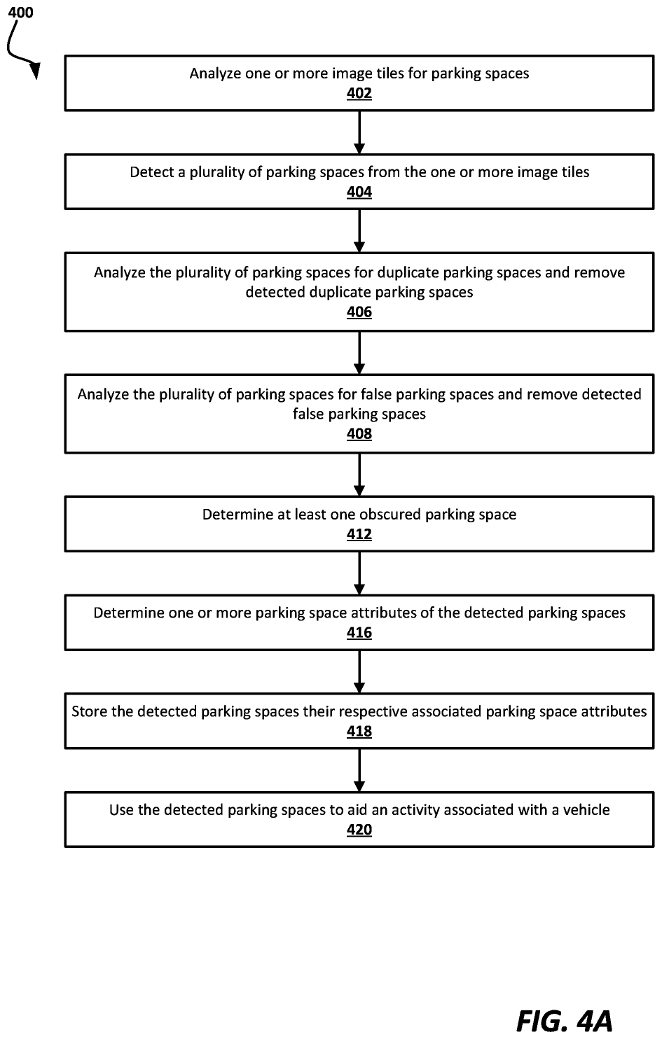

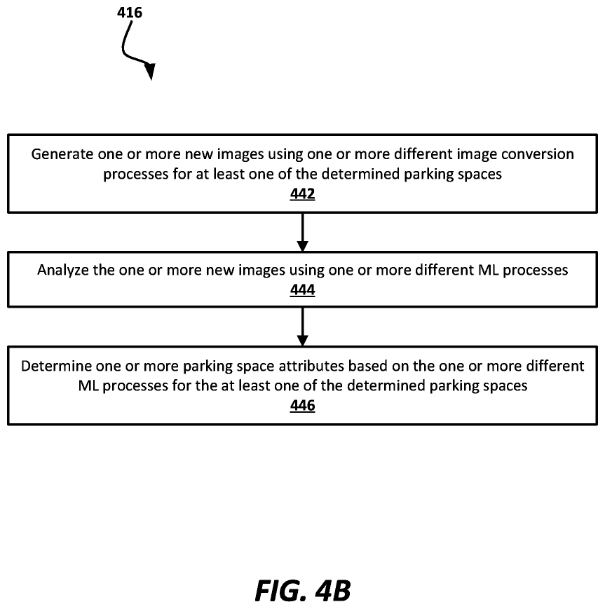

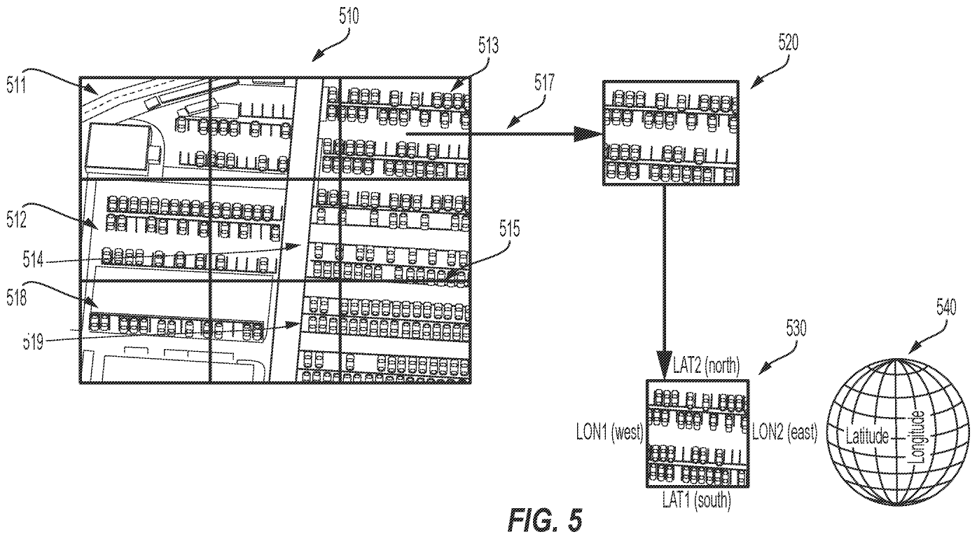

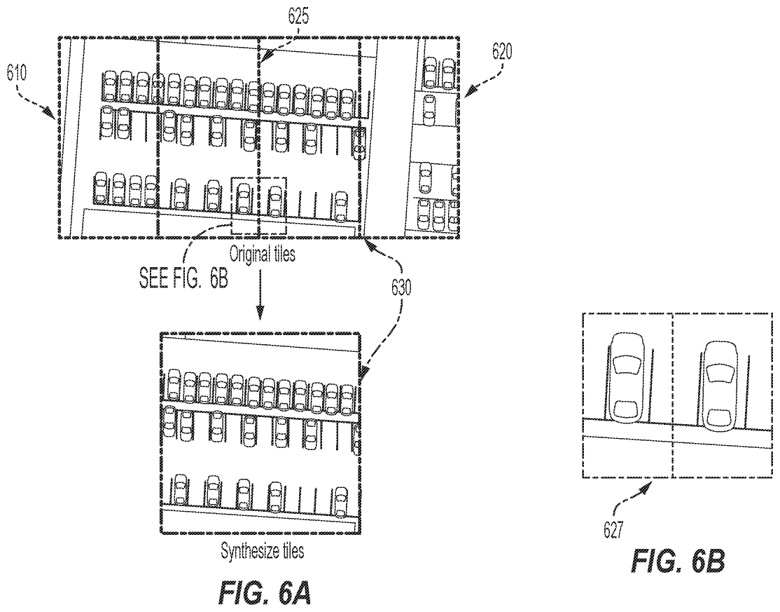

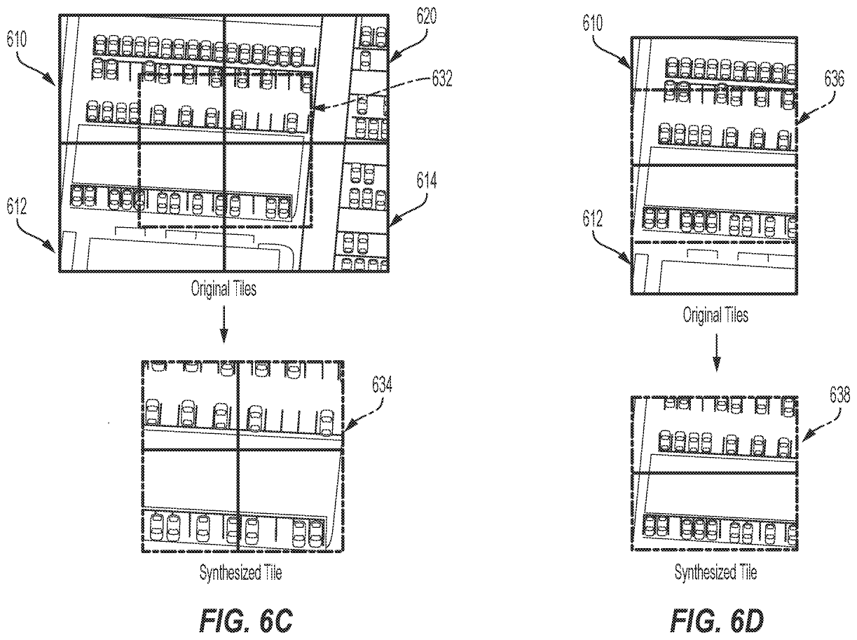

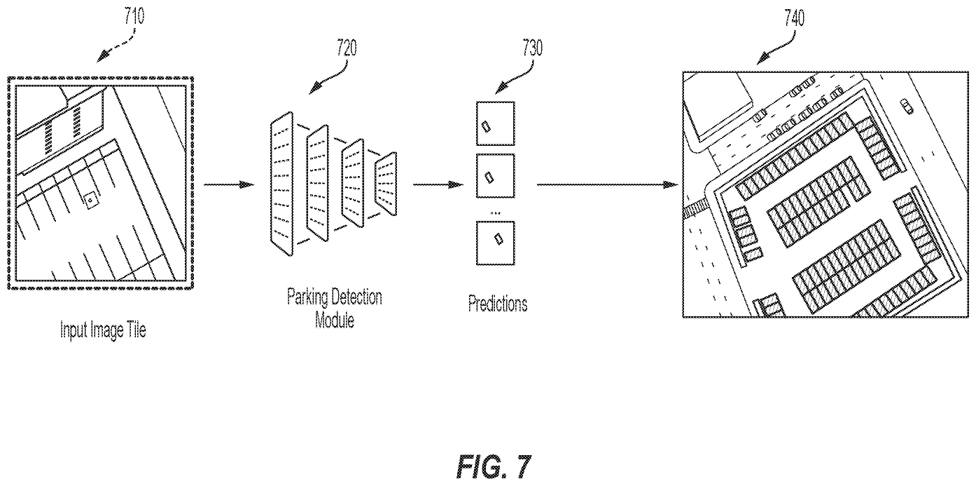

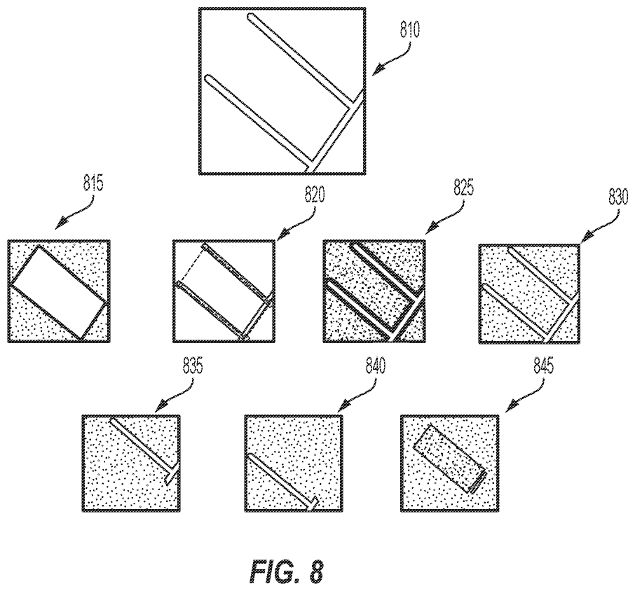

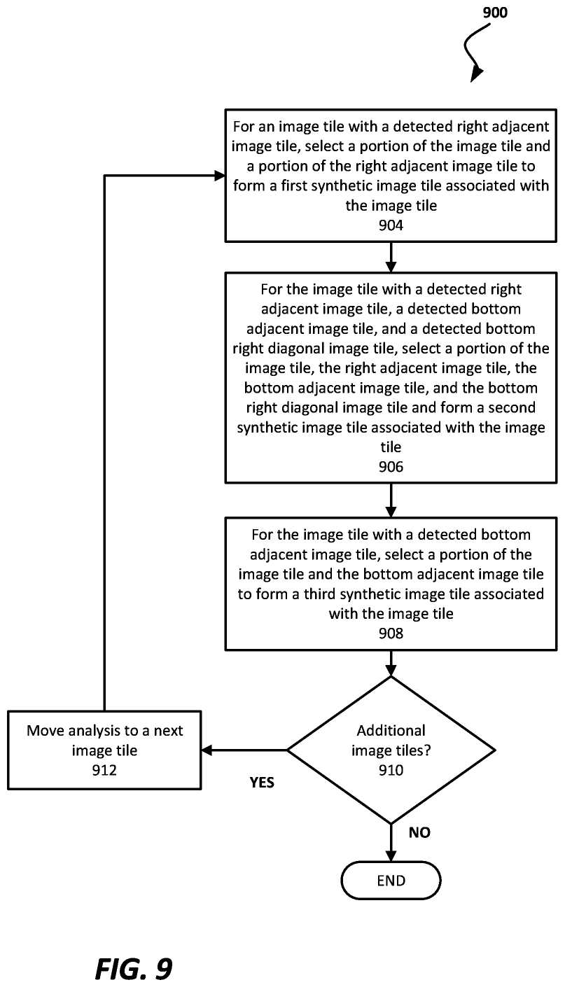

In some implementations, the parking space detection server 140 includes a computer and/or a server. By way of non-limiting example, the parking space detection server 140 may include one or more of a server, a desktop computer, a laptop computer, a handheld computer, a tablet computing platform, and/or, other computing platforms. In some implementations, parking space detection server 140 includes a plurality of computers and/or a of plurality servers. In some implementations, the server 140 is a computer, either a physical machine and/or a virtual machine instance and/or several machines or virtual instances united together that may be housed in a data center. In some implementations, parking space detection server 140 may include, but are not limited to, interface devices such as computer monitors, touch screens, buttons, keyboards, etc. In some implementations, parking space detection server 140 may include one or more processors, one or more types of non-transitory memory devices (e.g., RAM, ROM, etc.), network interface devices, etc. Further details of some implementations of the parking space detection server 140 are discussed below, such as in connection with FIG. 2, FIG. 3, FIG. 4A, FIG. 4B, FIG. 5, FIG. 6A, FIG. 6B, FIG. 6C, FIG. 6D, FIG. 7, FIG. 8, and FIG. 9.

FIG. 2 is a block diagram illustrating a parking space detection server 200, according to some implementations of the present disclosure. In some implementations, parking space detection server 200 illustrated in FIG. 2 is one possible implementation of parking space detection server 140 previously discussed. In some implementations, parking space detection server 200 may include one or more computing platforms. Parking space detection server 200 may be configured to communicate with one or more devices (e.g., end user device 110, other servers, etc.) according to a client/server architecture, a peer-to-peer architecture, distributed computing architecture, and/or other suitable architectures. Users may access parking space detection server 200 via certain devices (e.g., end user device 110 and/or other suitable devices). In some implementations, the parking space detection server 200 may include one or more processers 202, one or more electronic storage devices 215 (e.g., non-transitory memory devices), and machine-readable instructions 204.

Parking space detection server 200 may be configured by machine-readable instructions 204. Machine-readable instructions 204 may include one or more instruction modules. The instruction modules may include computer program modules. The instruction modules may include one or more of an image tile module 210 and a parking space detection module 220, and/or other instruction modules.

In some implementations, image tile module 210 is configured to execute and run on the parking space detection server 200. In some implementations, image tile module 210 is configured to provide images for the parking space detection module 220 to process. In some implementations, the image tile module 210 includes one or more ML or AI modules. In some implementations, the images are satellite images. In some implementations, the image tile module 210 is configured to divide images into one or more smaller segments. In some implementations, the image tile module 210 can divide images into segments to create one or more image tiles of the images. In some implementations, the image tile module 210 may associate one or more georeferenced locations associated with one or more of the image tiles. In some implementations, the georeferenced locations associated with the image tiles may include georeferenced locations of one or more sides of an image tile. FIG. 5 illustrates a satellite image 510. In some implementations, the satellite image 510 can be divided into one or more segments or image tiles. In some implementations, as illustrated in FIG. 5, the satellite image 510 is divided into multiple image tiles in accordance with the image tile divider 515 (e.g., the visible nine image tiles). It should be appreciated that the satellite image 510 can be divided into any suitable number of image tile segments (e.g., none, one or more, more than nine image tiles, less than nine image tiles, etc.). In some implementations, one or more individual image tiles of satellite image 510 can be associated with georeferenced data. As an example, arrow 517 shows an image tile 520 of satellite image 510 being selected to have georeferenced data associated with one or more sides of the image tile 520. As illustrated in FIG. 5, outside edges of the image tile 520 are associated with latitude and longitude georeferenced data, as shown as image tile 530. In some implementations, one or more or all of the image tiles created by image tile divider 515 are associated with georeferenced data like image tile 520. Globe 540 is shown merely for reference to illustrate the latitude and longitude. In some implementations, image tile module 210 of parking space detection server 200 may store created image tiles in electronic storage 215 or some other suitable storage location. While parking space detection server 200 is depicted as having image tile module 210 to create tiles segments, in some implementations, the images and image tiles used by parking space detection server 200 can be obtained from one or more alternative sources. In some implementations, where parking space detection server 200 does not need to process images into image segments, parking space detection server 200 does not include an image tile module 210.

In some implementations, image tile module 210 is configured to create synthesized image tiles (also referred to herein as synthetic image tiles) from two or more image tiles. FIG. 9 is a flowchart of an example process of creating synthesized image tiles from original image tiles (e.g., image tiles such as the image tiles shown in satellite image 510 in FIG. 5), according to some implementations of the present disclosure. In some implementations, synthesized image tiles can be used along with original image tiles in the detection of parking spaces. Synthesized image tiles can help increase the accuracy of parking space detection by creating new image tiles from original image tiles to better show parking spaces that may have been split or difficult to recognize by machine vision when viewed in one or more original image tiles (See e.g., FIG. 6B). In some implementations, one or more process blocks of FIG. 9 may be performed by a device, such as parking space detection server 200, some other suitable device, or a combination of devices. In some implementations, image tile module 210 of parking space detection server 200 may perform process 900 of FIG. 9. In some implementations, the process 900 can be performed by other modules, such as parking space detection module 220.

As shown in FIG. 9, at 904, in some implementations, process 900 may include, for an original image tile with a detected right adjacent image tile, image tile module 210 selecting a portion of the original image tile and a portion of a right adjacent image tile to form a first synthetic image tile associated with the original image tile. FIG. 6A illustrates the formation of a synthetic image tile from two adjacent image tiles, such as image tile 610 and image tile 620 that were created from a larger satellite image. For example, image tile 610 may correspond to image tile 512 from satellite image 510 in FIG. 5 and image tile 620 may correspond to image tile 514 from satellite image 510 in FIG. 5. For purposes of explaining 904, image tile 610 can be an original image tile and image tile 620 can be the detected right adjacent image tile. In some implementations, because image tile 610 is the focus of the analysis to create new synthetic image tiles, image tile 610 is considered an original image tile. In some implementations, when image tile 620 is the focus of analysis to create new synthetic image tiles, then image tile 620 can be considered an original image tile. Dotted line 625 illustrates the dividing point between image tile 610 and image tile 620. A close-up view 627 in FIG. 6B of portions of image tile 610 and image tile 620 show that dotted line 625 crosses through a parking space. It should be appreciated that in some implementations, image tile 610 and image tile 620 may have different portions of an object, like a same parking space, in their respective image tiles. In some implementations, when a division like this occurs, it can be difficult for parking space detection server 200 to detect a partial object, like a partial parking space in either image tile 610 or image tile 620, on their own. In some implementations, to address this deficiency, image tile module 210 may create synthesized image tiles from two or more image tiles. As illustrated in FIG. 6A, image tile module 210 may select a portion of an image in image tile 610 and a portion of an image in image tile 620 to create a synthesized image tile 630. In some implementations, a synthesized image tile 630 includes a full object, such as the divided parking space shown in close up view 627 of FIG. 6B, in one synthesized image tile to reduce or eliminate the chance that parking space detection server 200 may miss objects that are divided among two or more image tiles. Any suitable portion of image tile 610 and image tile 620 can be selected to create a synthesized image tile.

In some implementations, this first synthetic image tile can be labeled as associated with the original image tile. In some implementations, the original image tile and one or more synthetic tiles created based on the original image tile can form an associated set of image tiles. In some implementations, the original image tile is labeled as index 0 in the associated set of image tiles (or with some other suitable distinguishing label). In some implementations, the first synthetic tile can be labeled as index 1 in the associated set of image tiles (or with some other suitable distinguishing label). In some implementations, when parking spaces are detected (e.g., as explained in FIG. 4A), a detected parking space can be assigned a label associated with the image tile it was derived from. For example, in some implementations, if a detected parking space was found in the original image tile, the detected parking space can be labeled as associated with the original image tile index 0. As a further example, in some implementations, if a detected parking space was found in the first synthetic image tile, the detected parking space can be labeled as associated with the first synthetic image tile index 1. In some implementations, labeling associated image tiles and parking spaces detected from these image tiles can be useful when performing a deduplication process (e.g., removing or otherwise excluding duplicate detected parking spaces that may occur when using synthetic image tiles), which is discussed below in FIG. 4A.

While FIG. 6A illustrates a left adjacent and a right adjacent image tile that can be used to create a synthesized image tile, image tiles can be created from other image tile combinations. For example, a portion of an image tile that is below image tile 610 can be combined with image tile 610 to form a synthesized image tile. In some implementations, portions of more than two image tiles can be combined to form a synthesized image tile. In some implementations, synthesized image tile 630 can be stored in electronic storage 215. It should be appreciated that synthesized image tile 630 can be stored in any suitable database in any location. In some implementations, synthesized image tile 630 is not stored in a database and is created at run time, while image tiles are being analyzed, such as by parking space detection module 220 and held in temporary memory for purposes of detecting parking spaces. It should be appreciated that in some implementations, if image tile module 210 does not detect a right adjacent image tile for the original image tile, image tile module 210 does not perform 904 in FIG. 9. As an example, if image tile module 210 were processing image tile 513 in FIG. 5, image tile module 210 may determine that image tile 513 does not have a right adjacent image tile, thus, image tile module 210 may not perform 904 in FIG. 9 for the image tile 513.

Returning to FIG. 9, block 906 illustrates a second synthetic image tile that can be created from the original image tile, such as image tile 610. In some implementations, for the original image tile with a detected right adjacent image tile, a detected bottom adjacent image tile, and a detected bottom right diagonal image tile, image tile module 210 may select a portion of the original image tile, the right adjacent image tile, the bottom adjacent image tile, and the bottom right diagonal image tile and form a second synthetic image tile associated with the original image tile. FIG. 6C illustrates an example of 906 of FIG. 9, where original image tile 610 with the adjacent and diagonal image tiles that can be used to form a second synthetic image tile. In some implementations, image tile module 210 may determine that the original image tile 610 has a detected right adjacent image tile 620, a detected bottom adjacent image tile 612, and a detected bottom right diagonal image tile 614. In some implementations, the detected bottom adjacent image tile 612 corresponds to image tile 518, and a detected bottom right diagonal image tile 614 corresponds to image tile 519. In some implementations, image tile module 210 may select a portion of the original image tile 610, the right adjacent image tile 620, the bottom adjacent image tile 612, and the bottom right diagonal image tile 614 as shown by dotted lines 632. It should be appreciated that any suitable portion of each of the original image tile 610, the right adjacent image tile 620, the bottom adjacent image tile 612, and the bottom right diagonal image tile 614 can be selected to form the second synthetic image tile. In some implementations, the areas selected based on dotted lines 632 becomes the second synthetic image tile 634. In some implementations, this second synthetic image tile can be labeled as associated with the original image tile. In some implementations, the original image tile, the first synthetic image tile, and the second synthetic image tile created based on the original image tile are part of the associated set of image tiles. In some implementations, the second synthetic image tile is labeled with index 2 in the associated set of image tiles (or with some other suitable distinguishing label). In some implementations, synthesized image tile 634 can be stored in electronic storage 215. It should be appreciated that synthesized image tile 634 can be stored in any suitable database in any location. In some implementations, synthesized image tile 634 is not stored in a database and is created at run time, while image tiles are being analyzed, such as by parking space detection module 220 and held in temporary memory for purposes of detecting parking spaces. It should be appreciated that in some implementations, if image tile module 210 does not detect a right adjacent image tile, a bottom adjacent image tile, or a bottom right diagonal image tile for the original image tile, image tile module 210 does not perform 906 in FIG. 9. As an example, if image tile module 210 were processing image tile 513 in FIG. 5, image tile module 210 may determine that image tile 513 does not have a right adjacent image tile, thus, image tile module 210 may not perform 906 in FIG. 9 for the image tile 513.

In some implementations, as shown in FIG. 9 at 908, a third synthetic image tile can be created from the original image tile, such as image tile 610. In some implementations, for the original image tile with a detected bottom adjacent image tile, image tile module 210 may select a portion of the original image tile and a bottom adjacent image tile to form a third synthetic image tile associated with the original image tile. FIG. 6D illustrates an example of block 908 of FIG. 9, where original image tile 610 with the adjacent bottom image tile can be used to form a third synthetic image tile. In some implementations, image tile module 210 may determine that original image tile 610 has a detected bottom adjacent image tile 612. In some implementations, the detected bottom adjacent image tile 612 corresponds to image tile 518. In some implementations, image tile module 210 may select a portion of the original image tile 610 and the bottom adjacent image tile 612 as shown by dotted lines 636. It should be appreciated that any suitable portion of each of the original image tile 610 and the bottom adjacent image tile 612 can be selected to form the third synthetic image tile. In some implementations, the area selected based on dotted lines 636 becomes the third synthetic image tile 638. In some implementations, this third synthetic image tile can be labeled as associated with the original image tile. In some implementations, the original image tile, the first synthetic image tile, the second synthetic image tile, and the third synthetic image tile created based on the original image tile are part of the associated set of image tiles. In some implementations, the third synthetic image tile is labeled as index 3 in the associated set of image tiles (or with some other suitable distinguishing label). In some implementations, synthesized image tile 638 can be stored in electronic storage 215. It should be appreciated that synthesized image tile 638 can be stored in any suitable database in any location. In some implementations, synthesized image tile 638 is not stored in a database and is created at run time, while image tiles are being analyzed, such as by parking space detection module 220 and held in temporary memory for purposes of detecting parking spaces. It should be appreciated that in some implementations, if image tile module 210 does not detect a bottom adjacent image tile to the original image tile, image tile module 210 does not perform 908 in FIG. 9. As an example, if image tile module 210 were processing image tile 518 in FIG. 5, 210 may determine that image tile 518 does not have a bottom adjacent image tile, thus, 210 may not perform 908 in FIG. 9 for image tile 518.

It should be appreciated that the process 900 in FIG. 9 can be repeated for one or more image tiles. In some implementations, for example, image tile module 210 may determine if there are additional image tiles to process as shown at 910 in FIG. 9. In some implementations, if image tile module 210 determines there is at least one additional image tile to process, image tile module 210 may start the process 900 again as shown at 912 in FIG. 9. For example, the process 900 can be started again at 904 for a next image tile. In some implementations, process 900 can be repeated for one or more image tiles, such as the image tiles in satellite image 510. In some implementations, process 900 may start with the top left image tile 512 in satellite image 510 and run through the forgoing blocks in process 900. In some implementations, image tile module 210 may run through process 900 going from a far left image tile to a far right image tile, such as the image tile 511 in satellite image 510 to image tile 513 in satellite image 510. In some implementations, image tile module 210 may then continue process 900 on a next row below the image tile 511. While process 900 was described as performed on image tiles from left to right, process 900 can be reconfigured to move in any suitable direction, such as right to left, top to bottom, bottom to top in various different implementations. It should also be appreciated that one or more blocks in process 900 may also be reconfigured as appropriate when creating synthetic image tiles from original image tiles in a different direction, such as analyzing left adjacent image tiles rather than right adjacent image tiles, which is different than was described in FIG. 9.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

As noted above, synthesized image tiles are used to supplement image tiles in the analysis of objects, such as parking spaces in satellite images. Using synthesized image tiles for image processing and analysis is an improvement over other image processing methods to detect parking spaces. Using the sampling method described in connection with FIG. 6A, FIG. 6B, FIG. 6C, FIG. 6D, and FIG. 9 to create synthesized image tiles for image processing (e.g., as is further described in connection with FIG. 4A) uses less memory and computer processing power than when analyzing objects in images (e.g., parking spaces) with other image analysis methods and also enables faster processing of images (e.g., to detect parking spaces) than with other image analysis methods.

In some implementations, parking space detection module 220 is configured to execute and run on the parking space detection server 200 to detect parking spaces and features associated with detected parking spaces from one or more images. In some implementations, the parking space detection module 220 includes one or more ML models and/or one or more rule based algorithms to aid in the parking space detection. In some implementations using ML, one or more ML models are based on a convolutional neural network ML model. In some implementations, parking space detection module 220 may include an ML model for object localization. In some implementations, the object localization may include processing functions to visually recognize objects, such as parking spaces, in images. In some implementations, parking space detection module 220 may include an ML model for object detection. In some implementations, the object detection processing functions may focus on certain special features that are associated with an object, such as special signs (e.g., handicap, snow emergency route, no parking days/times, etc.). In some implementations, the parking space detection module 220 may include an ML model for parking space classification. In some implementations, the parking space classification processing function may focus on certain features of a parking space (e.g., line style, line color, surface type, etc.). It should be appreciated that other suitable ML or AI models can be used for parking space detection. In some implementations, rule based algorithms can be used for one or more features of parking space classification such as symmetric space detection, angles of parking spaces (e.g., rectangle, parallelograms), etc. In some implementations, parking space detection module 220 can be configured to detect parking spaces and features associated with detected parking spaces from satellite images, image tiles and synthesized image tiles derived from satellite images, or other image sources. In some implementations, parking space detection module 220 can obtain images to process from any suitable source. In some implementations, parking space detection module 220 can obtain images to process from electronic storage 215 or other suitable electronic storage systems. In some implementations, the parking space detection module 220 is associated with one or more databases, such as PostgreSQL™, PostGIS™, Microsoft™ SQL Server databases, to store images, image tiles, tagged parking spaces, tagged features of parking spaces, ancillary and core data, used in operating the parking space detection module 220 as well as serving as a repository for any suitable data arising from parking space detection using the parking space detection module 220.

While certain features and functions of the image tile module 210, and/or parking space detection module 220 were described, it should be appreciated that the features and functions of these modules are not limited to the description herein. Furthermore, additional features and functions of the parking space detection server 200 and its modules will be described in further detail below.

In some implementations, parking space detection server 200 may be operatively linked to other devices via one or more electronic communication links. For example, such electronic communication links may be established, at least in part, via a network such as the Internet and/or other networks. It will be appreciated that this is not intended to be limiting, and that the scope of this disclosure includes implementations in which parking space detection server 200 may be operatively linked to other devices via some other suitable communication media. In some implementations, parking space detection server 200 may be operatively linked to other parking space detection servers via suitable communication media. By way of non-limiting example, given parking space detection server 200 may include one or more of a server, a desktop computer, a laptop computer, a handheld computer, a tablet computing platform, and/or other computing platforms.

Parking space detection server 200 may include electronic storage 215, one or more processors 202, and/or other components. Parking space detection server 200 may include communication lines, or ports to enable the exchange of information with a network and/or other computing platforms. Illustration of parking space detection server 200 in FIG. 2 is not intended to be limiting. Parking space detection server 200 may include a plurality of hardware, software, and/or firmware components operating together to provide the functionality attributed herein to parking space detection server 200. For example, parking space detection server 200 may be implemented by a cloud of computing platforms operating together as parking space detection server 200.

Electronic storage 215 may comprise non-transitory storage media that electronically stores information. The electronic storage media of electronic storage 215 may include one or both of system storage that is provided integrally (e.g., substantially non-removable) with parking space detection server 200 and/or removable storage that is removably connectable to parking space detection server 200 via, for example, a port (e.g., a USB port, a firewire port, etc.) or a drive (e.g., a disk drive, etc.). Electronic storage 215 may include one or more of optically readable storage media (e.g., optical disks, etc.), magnetically readable storage media (e.g., magnetic tape, magnetic hard drive, etc.), electrical charge-based storage media (e.g., EEPROM, RAM, etc.), solid-state storage media (e.g., flash drive, etc.), and/or other electronically readable storage media. Electronic storage 215 may include one or more virtual storage resources (e.g., cloud storage, a virtual private network, and/or other virtual storage resources). Electronic storage 215 may store software algorithms, information determined by processor(s) 202, information received from parking space detection server 200, information received from other devices (e.g., end user devices 110, vehicles, etc.), and/or other information that enables parking space detection server 200 to function as described herein.

Processor(s) 202 may be configured to provide information processing capabilities in parking space detection server 200. As such, processor(s) 202 may include one or more of a digital processor, an analog processor, a digital circuit designed to process information, an analog circuit designed to process information, a state machine, and/or other mechanisms for electronically processing information. Although processor(s) 202 is shown in FIG. 2 as a single entity, this is for illustrative purposes only. In some implementations, processor(s) 202 may include a plurality of processing units. These processing units may be physically located within the same device, or processor(s) 202 may represent processing functionality of a plurality of devices operating in coordination. Processor(s) 202 may be configured to execute image tile module 210, parking space detection module 220, and/or other modules. Processor(s) 202 may be configured to execute image tile module 210, parking space detection module 220, and/or other modules by software; hardware; firmware; some combination of software, hardware, and/or firmware; and/or other mechanisms for configuring processing capabilities on processor(s) 202. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although image tile module 210 and parking space detection module 220 are illustrated in FIG. 2 as being implemented within a single processing unit, in implementations in which processor(s) 202 includes multiple processing units, one or more of image tile module 210 and parking space detection module 220 may be implemented remotely from the other modules. The description of the functionality provided by the different image tile module 210 and parking space detection module 220 described below is for illustrative purposes, and is not intended to be limiting, as any of image tile module 210 and parking space detection module 220 may provide more or less functionality than is described. For example, one or more of image tile module 210 and/or parking space detection module 220 may be eliminated, and some or all of its functionality may be provided by other ones of image tile module 210 and/or parking space detection module 220. As another example, processor(s) 202 may be configured to execute one or more additional modules that may perform some or all of the functionality attributed below to one of image tile module 210 and/or parking space detection module 220. As noted above, one or more processors at a different server from parking space detection server 200 can be configured to execute some or all of the functionality provided by image tile module 210 and/or parking space detection module 220.

FIG. 3 is a flowchart of an example process 300 of training a parking space detection system, according to some implementations of the present disclosure. In some implementations, the parking space detection system uses ML and/or AI to process images to detect parking spaces in the images. In some implementations, the ML and AI can be trained and optimized to efficiently and accurately process images. In some implementations, one or more process blocks of FIG. 3 may be performed by a device, such as parking space detection server 140, end user device 110, some other suitable device, or a combination of devices. For purposes of discussion herein, the process will be described in term of a system using end user device 110 and parking space detection server 140.

In some implementations, at 302, a set of training data set can be created based on one or more images. In some implementations, training data is created by identifying and tagging one or more parking spaces in one or more images. In some implementations, the process of tagging one or more parking spaces may include identifying additional features of the tagged parking spaces. For example, in some implementations, the additional features of the tagged parking spaces may include, but are not limited to, line color, surface type, line style, shape, painted color, etc. Features of the tagged parking spaces can be saved in association with the tagged parking spaces. In some implementations, the process of creating training data is manually performed. In some implementations, a user, such as a user at an end user device 110 may run a geographic information system (GIS) program and tag/mark parking spaces and associated features found in one or more images, such as satellite images. In some implementations, the tagged/marked parking spaces are saved for later use, such as by parking space detection server 140. In some implementations, the user may create the training data on end user device 110. In some implementations, the user may create the training data on other suitable devices, such as a server. In some implementations, the server is parking space detection server 140. In some implementations, the parking space detection server 140 may include a GIS module or a training module to enable the user to create the training data. In some implementations, the training data can be automated. In some implementations, the certain portions of the training data can be obtained from other sources, such as OpenStreetMap™. In some implementations, the training data includes 1000s of tagged parking spaces. It should be appreciated that the training data may include any suitable number of tagged parking spaces. In some implementations, the greater the number of tagged parking spaces and the greater the variety of tagged parking spaces, the better and more accurate the ML and/or AI in parking space detection server 140 will become at detecting parking spaces and associated features in later processed images.

In some implementations, additional training data can be created from augmented data on tagged/marked parking spaces. For example, image data for a tagged parking space can be duplicated and altered to create additional tagged parking spaces (e.g., the augmented data). In some implementations, a tagged parking space can be rotated a predetermined amount, such as 90 degrees, 180 degrees or some other suitable amount to create one or more additional tagged parking spaces from the original tagged parking space to add to the training data. In some implementations, a tagged parking space can have one or more filters applied to the image data to create one or more new tagged parking spaces to add to the training data. As one example, a black and white filter may be applied to a tagged parking space to alter the image and create a new tagged parking space to add to the training data. As another example, a color or tone adjustment filter can be applied to a tagged parking space to alter the image and create a new tagged parking space to add to the training data. Another suitable number of different filters can be applied to a tagged parking space to alter the image and create a new tagged parking space to add to the training data. In some implementations, these new tagged parking spaces from original tagged parking spaces help to augment training data from original tagged parking spaces and enable a machine learning or artificial intelligence algorithm learn additional information about images it may encounter in the future. In some implementations, the augmented data is determined based on attributes associated with a particular tagged parking space. For example, if parking space detection server 200 determines that a tagged parking space has one or more attributes that are rare, parking space detection server 200 may determine that augmented data should be created from the tagged parking space. For example, if parking space detection server 200 determines that it does not have many tagged parking spaces with blue lines, the parking space detection server 200 may create one or more different new tagged parking spaces that are alterations of the tagged parking space (e.g., one or more rotated images of the tagged parking space, a flipped image of the tagged parking space, one or more color adjusted images of the tagged parking space). These altered new tagged parking spaces enable a machine learning or artificial intelligence model to learn more variations of parking spaces that have blue lines, which may not have been in the original data set of the training data. In some implementations, if parking space detection server 200 determines that a tagged parking space few or no attributes that are rare amongst the training data, the parking space detection server 200 may not create any augmented data for the tagged parking space. In some implementations, if parking space detection server 200 determines that a tagged parking space has one or more attributes that are rare, the parking space detection server 200 may rank the rarity and determine how many augmented data variations of a tagged parking space to create based on the rarity. In some implementations, for a tagged parking space with one or more attributes that appear below a first predetermined threshold (e.g., appear in less than 10% of the training data or some other suitable threshold), parking space detection server 200 may create three or more augmented data variations for the tagged parking space. In some implementations, for a tagged parking space with one or more attributes that appear below a second predetermined threshold (e.g., appearing in less than 40% of the training data or some other suitable threshold), parking space detection server 200 may create two or more augmented data variations for the tagged parking space. In some implementations, for a tagged parking space with one or more attributes that appear below a third predetermined threshold (e.g., appearing in less than 70% of the training data or some other suitable threshold), parking space detection server 200 may create one or more augmented data variations for the tagged parking space. It should be appreciated that the quantity of augmented data variations that are created for a tagged parking space can be set at any suitable quantity for any suitable threshold level. It should also be appreciated that the threshold levels for determining rarity can be set to any suitable threshold level and any number of different rarity threshold levels can be set.

In some implementations, at 304, parking space detection server 140 can be trained using the created tagged images in the training data set using standard techniques for training an ML or AI based system. For example, parking space detection module 220 in parking space detection server 200 can be trained using the images with tagged parking spaces and identified features in the training data set.

In some implementations, at 306, the parking space detection server 140 is tested using one or more test images. In some implementations, the testing includes providing test images to the parking space detection server 140 to detect parking spaces in the test images and to determine features associated with the detected parking spaces. In some implementations, the test images are satellite images including parking spaces. In some implementations, parking space detection server 140 outputs identified (tagged/marked) parking spaces and tagged features associated with the identified parking spaces from the test images.

In some implementations, at 308, the output from the parking space detection server 140 can be evaluated against ground truth data. In some implementations, the test images can be separately and manually tagged (for parking spaces) and have identified associated features with the tagged parking spaces to create ground truth data. In some implementations, ground truth data can be manually created. In some implementations, the output of parking space detection server 140 (e.g., the parking spaces detected/tagged by parking space detection server 140) is compared to the ground truth data to determine the errors and the accuracy of the parking space detection server 140 at detecting parking spaces and identifying associated features. In some implementations, the results of the evaluation against ground truth data testing may identify areas of adjustment for parking space detection server 140 to create more accurate results. In some implementations, at 310, the parking space detection server 140 can be adjusted based on outcome of the evaluation. In some implementations, after adjustments are made to parking space detection server 140, the testing at 306, evaluation at 308, and adjustment at 310 can be run one or more additional times. In some implementations, the testing at 306, evaluation at 308, and adjustment can be run until a predetermined threshold level of accuracy is achieved or errors are below a predetermined threshold level for errors.

FIG. 4A is a flowchart of an example process of detecting parking spaces and various features of parking spaces, according to some implementations of the present disclosure. In some implementations, one or more process blocks of FIG. 4A may be performed by a device, such as parking space detection server 200, some other suitable device, or a combination of devices. As shown in FIG. 4A, at 402, in some implementations, process 400 may include analyzing one or more image tiles (as well as synthesized image tiles) for parking spaces. For example, parking space detection server 200 may be provided one or more image tiles and parking space detection server 200 may analyze one or more image tiles for parking spaces and features associated with any detected parking spaces. As an example, FIG. 7 illustrates an input image tile 710 (e.g., an image tile) that is provided to parking space detection server 200 for analysis. In some implementations, parking space detection module 220 of parking space detection server 200 performs one or more of the functions discussed in FIG. 4A.

As also shown in FIG. 4A, at 404, in some implementations, process 400 may include the parking space detection server 200 detecting one or more parking spaces or a plurality of parking spaces from the one or more image tiles (e.g., original image tiles and/or synthetic image tiles). In some implementations, 404 is the object localization process to visually recognize objects, such as parking spaces, in images. In some implementations, parking space detection module 220 of parking space detection server 200 may process the input image tile 710 to analyze for parking spaces. As an example, FIG. 7 illustrates a convolutional neural network (CNN) based parking detection module 720 of parking space detection module 220 processing convolutional layers derived from the input image tile 710. In some implementations, the resulting output from parking space detection module 220 may include one or more predictions of parking spaces detected from the input image tile 710. As an example, FIG. 7 illustrates parking space detection module 220 predictions for detected parking spaces 730. In some implementations, the forgoing process is repeated for one or more image tiles provided to parking space detection server 200.

As noted above, parking space detection module 220 may tag/mark and save detected parking spaces from the image tiles. In some implementations, the tagging/marking of a detected parking space may include saving georeferenced coordinates of the detected parking space. In some implementations, the tagging/marking of a detected parking space may include saving determined attribute information associated with the detected parking space. In some implementations, tagging/marking and saving may include parking space detection module 220 creating and saving individual images of detected parking spaces from the image tiles. In some implementations, the tagging/marking may include associating additional information to one or more detected parking spaces. In some implementations, the additional information includes the provenance of the detected parking space (e.g., whether the detected parking space was derived from an original image tile or a particular synthetic image tile). For example, for a parking space detected from an original image tile (e.g., image tile 610), parking space detection module 220 may associate the detected parking space with a label such as index 0 to indicate that the detected parking space was derived from an original image tile. For a parking space detected from a synthetic image tile (e.g., synthetic image tile 630), parking space detection module 220 may associate the detected parking space with a label such as index 1 to indicate that the detected parking space was derived from a synthetic image tile. Another detected parking space could be associated with a different index value depending on the original image tile or synthetic image tile from which it was derived. In some implementations, the additional information may include, but is not limited to, information identifying a specific image tile (e.g., image tile 610 vs image tile 620 vs synthesized image tile 630).

In some implementations, as shown in FIG. 7, the parking space detection server 200 can provide an output 740 showing detected/tagged parking spaces derived from analyzing one or more input image tiles (e.g., original image tiles and/or synthetic image tiles). In some implementations, parking space detection server 200 can be provided with input image tiles for entire towns, cities, countries and develop a map of parking spaces detected in the image tiles. In some implementations, as discussed herein, input image tiles may also include synthesized tiles as well as other images. In some implementations, images other than in image tile form can be processed by parking space detection server 200 to detect parking spaces. It should be appreciated, that in some implementations, parking space detection server 200 can be configured to perform additional analysis and processing to develop more accurate data with more details associated with the detected parking spaces. In some implementations, parking space detection server 200 stores detected and tagged parking spaces in one or more databases, such as in electronic storage 215.

Returning to FIG. 4A, at 406, in some implementations, process 400 may include parking space detection server 200 analyzing the plurality of detected parking spaces for duplicate detected parking spaces and removing duplicate detected parking spaces. In some implementations, detecting parking spaces from synthesized image tiles causes the parking space detection server 200 to detect and tag one or more parking spaces more than once (e.g., once during an analysis of an original input image tile and potentially one or more times after detecting parking spaces in one or more synthesized image tiles created from the original image tile, which can create one or more duplicate detected parking spaces). As an example, FIG. 6A illustrates image tile 610 sharing multiple parking spaces with synthesized image tile 630. In some implementations, parking space detection server 200 may detect parking spaces in image tile 610 that are the same as parking spaces detected in synthesized image tile 630, as discussed in connection with block 404. In some implementations, parking space detection server 200 can be configured to analyze detected parking spaces for threshold levels of overlap. For example, in some implementations, if parking space detection server 200 determines that more than 50% of two detected parking spaces overlap (e.g., based on comparing latitude and longitude coordinates associated with the detected parking spaces), parking space detection server 200 may determine that detected parking spaces are duplicates. It should be appreciated that the threshold percentage geometric overlap between two detected parking spaces geometries can be any suitable percentage. In some implementations, if parking space detection server 200 determines that less than a threshold percentage between two parking spaces are overlapping, the parking space detection server 200 may deem the spaces to be unique spaces, neighboring spaces, or adjacent spaces and keep a record of both detected spaces in an appropriate database.

As also shown in FIG. 4A at 406, in some implementations, when detecting that two parking spaces are duplicates, the parking space detection server 200 may remove one of the detected parking spaces that are deemed a duplicate (e.g., the parking space detected from the synthesized tile). In some implementations, parking space detection server 200 may flag one of the detected duplicate parking spaces as a duplicate parking space in place of removing the duplicate parking space (e.g., to avoid using duplicate parking spaces in a later analysis or application of the detected parking spaces). It should be appreciated that in some implementations, the parking space detection server 200 may be configured to remove the duplicate parking space determined from the original image tile rather than the duplicate parking space determined from a synthesized image tile. In some implementations, the remaining detected parking spaces can form a set of remaining plurality of parking spaces (also referred to herein as a new set of detected parking spaces).

In some implementations, the process of parking space detection server 200 determining and removing duplicate detected parking spaces of block 406 includes creating a new set of detected parking spaces (e.g., a set of remaining plurality of parking spaces) that excludes duplicate parking spaces. In some implementations, the process of block 406 can use the indexes or labels associated with detected parking spaces for the analysis. In some implementations, detected parking spaces (e.g., parking spaces detected in block 404) from original tiles (e.g., detected parking spaces labeled with index 0) can be added to the new set of detected parking spaces. In some implementations, the parking space detection server 200 analyzes detected parking spaces labeled with index values associated with synthetic image tiles. For example, in some implementations, the parking space detection server 200 may analyze detected parking spaces labeled with an index value of 1 against detected parking spaces already included in the new set of detected parking spaces. In some implementations, as noted above, parking space detection server 200 may compare one or more detected parking spaces labeled with an index value of 1 against detected parking spaces already included in the new set of detected parking spaces and determine if there is less than a threshold percentage of overlap with a detected parking space in the new set of detected parking spaces. In some implementations, the threshold percentage can be 50% or some other suitable threshold. If a detected parking space with an index value of 1 has less than a designated threshold percentage of overlap with a detected parking space in the new set of detected parking spaces, then the detected parking space with an index value of 1 is also added to the new set of detected parking spaces. On the other hand, if a detected parking space with an index value of 1 has more than a designated threshold percentage of overlap with a detected parking space in the new set of detected parking spaces, then the detected parking space with an index value of 1 is not added to the new set of detected parking spaces (e.g., it is excluded from the new set of detected parking spaces, essentially deleting or removing the duplicate detected parking space). In some implementations, this process is repeated for one or more detected parking spaces with other index values associated with synthetic tiles (e.g., associated synthetic tiles with index 2, index 3, etc.). It should be appreciated that the resulting new set of detected parking spaces may eliminate one or more duplicate parking spaces detected in block 404.

As is discussed herein, in various implementations, one or more blocks in process 400 can be performed in parallel or in a different order. In one such example, blocks 416 and 418 can be performed once parking spaces are detected at 404 and prior to or while performing block 406. In some such implementations, process 400 may use determined parking space attributes associated with one image tile and add such parking space attributes to another related image tile or to another image tile that is determined to have a certain percentage of overlap. As one example, in some implementations, if a detected parking space with an index value of 1 has more than a designated threshold percentage of overlap with a detected parking space in the new set of detected parking spaces (e.g., a parking space with an index of 0 that is related to the parking space with an index of 1, wherein there is more than a designated threshold percentage overlap), the parking space detection server 200 may be configured to compare determined parking space attributes between these two detected parking spaces and add and/or replace one or more determined parking space attributes saved in association with the parking space with an index of 0. For example, if the parking space with an index of 1 includes a determined parking space attribute of line color white, while the parking space with an index of 0 did not have a parking space attribute of line color, parking space detection server 200 may add the parking space attribute of line color white to the parking space with an index of 0. In the case of a discrepancy between parking space attributes (both parking spaces have attributes that are contradictory—such as the parking space with an index of 0 includes an attribute of line color white while the parking space with an index of 1 includes an attribute of line color blue), parking space detection server 200 may use one or more different techniques to resolve the discrepancy in stored detected parking space attributes. In some implementations, parking space detection server 200 may resolve the discrepancy by analyzing line colors attributes determined by one or more other parking spaces near the two parking spaces. In some implementations, if one or more surrounding detected parking spaces have attributes of line color blue, then parking space detection server 200 may determine that attribute of line color blue should replace attribute of line color white for the parking space with an index of 0 (e.g., determining that the parking space with an index of 1 like had the correct attributed detected over the attributed detected for the parking space with an index of 0 (e.g., which are likely the same space). In another example, in some implementations, parking space detection server 200 may resolve discrepancies between certain parking space attributes by examining other determined parking space attributes of the two overlapping parking spaces. For example, if a parking space with an index of 1 includes an attribute of parking space type as handicapped, then parking space detection server 200 may determine that the line color attribute for the parking space with an index of 0 should be set to the color typically used for a handicapped parking space in the geographic location (e.g., blue for the United States). Similarly, parking space detection server 200 may determine if one or both parking spaces (e.g., parking space with an index of 1 and parking space with an index of 0) both identified their respective parking spaces as handicapped parking spaces in their respective attribute data. In some implementations, parking space detection server 200 may look to external data sources to resolve such discrepancies. For example, parking space detection server 200 may compare data from sources like Open Street Maps data (or other suitable data sources) to determine additional information/attributes about the parking spaces. For example, Open Street Maps may include information that certain parking spaces are handicapped parking spaces, to help parking space detection server 200 resolve one or more attribute discrepancy between the two overlapping parking spaces. In some implementations, once the attributes are reviewed, the detected duplicate parking space can be removed or otherwise excluded from the resulting new set of detected parking spaces. It should be appreciated that other suitable techniques can be used to resolve detected discrepancies between attributes of overlapping parking spaces.

Returning to FIG. 4A, at 408, in some implementations, process 400 may include parking space detection server 200 analyzing the plurality of detected parking spaces for false parking spaces. In some implementations, the analysis is performed on detected parking spaces from the new set of detected parking spaces to avoid analyzing duplicate detected parking spaces. In some implementations, one or more objects in images, such as satellite images, may appear to have lines and contours that appear like parking spaces. For example, parking space detection server 200 may determine from a satellite image (or an input image tile) that an office building with thin white window trim in a repeating pattern is a parking lot and then tag the areas with the thin white window trim as parking spaces. In some implementations, to account for these false positive detected parking spaces, the parking space detection server 200 can be configured to compare the detected parking spaces against ground truth data. In some implementations, the ground truth data can be map data that, for example, identifies locations of buildings. It should be appreciated that having input image tiles with edges that are georeferenced with appropriate latitude and longitude coordinates will help parking space detection server 200 compare the input image tiles to the same coordinates in the ground truth map data that identifies buildings or building footprints. In some implementations, parking space detection server 200 can determine whether detected parking spaces are in the same location as a building or within a building footprint, according to the ground truth map data. In some implementations, if parking space detection server 200 identified parking spaces that overlap with a portion of a building footprint, parking space detection server 200 can be configured to further analyze the identified parking spaces to determine whether the identified parking spaces are on a building or garage rooftop. In some implementations, parking space detection server 200 can be configured to use street centerline or street graph data to eliminate falsely identified parking spaces. For example, in some cities, street or road markings may appear similar to parking spaces (e.g., white lines defining crosswalks or no parking zones). In some implementations, parking space detection server 200 can use the street data to remove falsely identified parking spaces (e.g., parking spaces that were determined in the middle of a street). Parking space detection server 200 may determine false parking spaces using other suitable methods.

As also shown at 408, in some implementations, process 400 may include parking space detection server 200 removing detected false parking spaces from the new set of detected parking spaces. In some implementations, parking space detection server 200 updates the one or more databases storing the detected parking spaces to either remove the detected false parking spaces from the new set of detected parking spaces or flag the detected false parking spaces to be excluded as detected parking spaces.

As shown in FIG. 4A, at 412, in some implementations, process 400 may include parking space detection server 200 determining at least one obscured parking space. In some implementations, an obscured parking space might be fully obscured or partially obscured. In some implementations, a fully obscured parking space may mean that substantial portions or all of the physical identifiers (e.g., features/attributes) of the parking space are not visible to inspection (e.g., a vehicle covers the parking space lines or one or more parking space lines). In some implementations, portions of the physical identifiers of a parking space might be obscured. For example, a vehicle is in a parking space and substantially all or a portion of the lines of the parking space are visible, but one or more attributes are obscured (e.g., a handicapped symbol is covered by a vehicle, tree cover or shadows obscure portions of a parking spot). In some implementations, parking space detection server 200 may analyze the input image tiles for obscured parking spaces. In some implementations, the analysis can be performed based on the remaining plurality of parking spaces (e.g., already detected parking spaces). In some implementations, the analysis can be based on detected vehicles. In some implementations, the analysis is based on the combination of detected vehicles and already detected parking spaces. As previously noted, input image tiles can be derived from satellite images taken of cities, towns, etc. Input image tiles may include cars parked in parking spaces. In some implementations, the cars may block or obscure features/attributes that define a parking space, preventing the parking space detection server 200 from directly detecting some parking spaces in input image tiles and/or detecting one or more attributes of a parking space. Input image tiles may have objects obscured by other objects (e.g., tree cover, shadows, buildings, etc.). Analyzing the image tiles for one or more parking spaces that may be obscured enables parking space detection server 200 to determine parking spaces that might have otherwise been missed, creating more accurate parking space detection.

In some implementations, parking space detection server 200 is configured to statistically determine the existence of one or more obscured parking spaces. As shown in FIG. 6A, image tile 610, image tile 620, and synthesized image tile 630 depict vehicles that obscured some of the parking space lines. In some implementations, parking space detection server 200 may determine parking spaces based on the presence of parked vehicles in the input image tiles. For example, if parking space detection server 200 has data indicating that particular coordinates are associated with a parking lot, parking space detection server 200 may determine that detected parked vehicles in a location without a corresponding to a parking space are likely associated with an obscured parking space. In some implementations, parking space detection server 200 may tag/mark the area around a vehicle as a parking space that was not previously tagged as a parking space. In some implementations, parking space detection server 200 may determine parking spaces based on the presence of scattered parking spaces that were detected in the input image tiles. In some implementations, the presence of one or more detected parking spaces that are scattered in a particular area in combination with ground truth data indicating that the scattered detected parking spaces are within a larger parking lot enables parking space detection server 200 to predict the location of other parking spaces within the larger parking lot. In some implementations, parking space detection server 200 may use a combination of detected vehicles and detected parking spaces that are adjacent to the detected vehicles to determine the existence of obscured parking spaces. For example, if parking space detection server 200 detects a vehicle and does not detect parking space lines (or detects partial features of a parking space) where the vehicle is positioned, but does detect one or more parking spaces that are adjacent or located substantially near the detected vehicle, the parking space detection server 200 may tag the area where the detected vehicle is located as a parking space. In some implementations, parking space detection server 200 updates the one or more databases storing the detected parking spaces to include newly detected obscured parking spaces. In some implementations, the newly detected obscured parking spaces can be added to the new set of detected parking spaces.

As shown in FIG. 4A, at 416, in some implementations, process 400 may include parking space detection server 200 determining one or more parking space attributes of the detected plurality of parking spaces (detected parking spaces including the detected obscured parking spaces, but without the false parking spaces and/or without the duplicate detected parking spaces). In some implementations, determining one or more parking space attributes may comprise object detection and parking space classification. As noted above, object detection and parking space classification processing may be performed by parking space detection module 220 in parking space detection server 200. In some implementations, parking space detection module 220 may include one or more ML classification models (e.g., decision tree, K-mean neighborhood, etc.) or deep learning algorithms based on a convolutional neural network to perform specialized image detection or vector analysis of images/objects, as applicable. In some implementations, object detection and parking space classification can also use rule based algorithms. In some implementations, object detection comprises detecting certain special features that are associated with an object, such as special signs within a parking space or located near a parking space that convey information and/or special functions for a parking space (e.g., handicap sign, snow emergency route, no parking days/times, permitted parking days/times, street cleaning, etc.). In some implementations, parking space classification comprises determining other physical features/attributes of a parking space (e.g., geometry, shape, width, line color, surface type, line style, shape, line condition, tire stop, curb classification, painted color, vehicle presence, etc.). In some implementations, parking space detection server 200 may reanalyze images, such as input image tiles, which have identified parking spaces to determine the attributes associated with the identified parking spaces.

In some implementations, parking space detection server 200 analyzes the detected parking spaces rather than reanalyzing an entire image or entire input image tiles. As one example, FIG. 8 illustrates examples of generated images from a detected parking space 810. For example, in some implementations, parking space detection server 200 can perform image preprocessing on a detected parking space 810 to generate the example images shown in FIG. 8 (e.g., image 815, image 820, image 825, image 830, image 835, image 840, and image 845). These images (e.g., image 815-image 845) help isolate one or more features of a detected parking space 810. In some implementations, when the images (e.g., image 815-image 845) are analyzed by parking space detection server 200, parking space detection server 200 can more efficiently detect features of a parking space such as, but not limited to, geometry, shape, width, line color, surface type, line style, shape, line condition, tire stop, curb classification, painted color, and vehicle presence associated with detected parking space 810. In some implementations, detected parking space 810 may be derived from input image tile 710 or some other image tile. In some implementations, image 815 shows an example of parking space detection server 200 determining a prediction mask of the detected parking space 810. In some implementations, image 820 shows an example of parking space detection server 200 determining the outer boundaries or skeleton of the detected parking space 810. In some implementations, the skeleton of the detected parking space 810 includes four vertices to help define the boundaries of the detected parking space. In some implementations, image 825 shows an example of a possible image preprocessing step that can be applied to detected parking space 810 to aid parking space detection server 200 in detecting one or more attributes of the detected parking space 810. In image 825, parking space detection server 200 inverted the image 825 to further highlight the detected parking space lines so that aspects of the lines can be easier to detect. In some implementations, image 830, image 835, image 840, and image 845 show examples of parking space detection server 200 extracting one or more contour/boundary lines and surface type of detected parking space 810. It should be appreciated that the generated examples in FIG. 8 are not limiting and parking space detection server 200 may perform one or more image preprocessing and postprocessing techniques to enable more accurate determination of parking space attributes. In some implementations, parking space detection server 200 stores one or more of the determined parking space features/attributes in a database, such as electronic storage 215. It should be appreciated that the determined parking space features/attributes can be stored in any suitable database.

In some implementations at 416, process 400 may include parking space detection server 200 determining one or more parking space features/attributes of at least one detected obscured parking space based on features/attributes determined from at least some of the plurality of parking spaces that were detected. For example, if many detected parking spaces within close proximity to a detected obscured parking space have white lines, parking space detection server 200 can assign the color type of the detected obscured parking space as having white lines. As another example, parking space detection server 200 may detect a parking space due to parking space lines being visible in an image tile, but other information about the detected parking space is obscured from view. In such an example, the parking space detection server 200 may assign one or more attributes to the detected parking space based on domain knowledge of regional parking space construction norms. In this example, if parking space detection server 200 determined that a parking space has blue lines, but other information about the parking space is obscured by a vehicle or for some other reason, the parking space detection server 200 may determine that blue lines in the region where the parking space was detected means that the parking space is a handicapped parking space. The parking space detection server 200 may tag the blue lined parking space as a handicapped parking space. As an alternative, parking space detection server 200 may determine that other nearby detected parking spaces use white lines, but the detected parking space that is obscured uses blue lines (where blue is usually used to indicate a handicapped parking space), then parking space detection server 200 may determine that there is a high probability that the parking space is associated with an attribute of a handicapped space. Other suitable logic can be used, such as blue lines combined with a determination that the blue lines are near an entrance of a building may cause parking space detection server 200 to tag the parking space as being a handicapped parking space. In some implementations, detected obscured parking spaces and their attributes are stored in a database, such as electronic storage 215. It should be appreciated that the detected obscured parking spaces and their attributes can be stored in any suitable database.

As further shown in FIG. 4A (and as previously discussed), at 418, in some implementations, process 400 may include storing the remaining plurality of parking spaces, the determined at least one obscured parking space, and their respective associated parking space attributes in a database, such as electronic storage 215. It should be appreciated that the remaining plurality of parking spaces, the determined at least one obscured parking space, and their respective associated parking space attributes can be stored in any suitable database at any suitable time (e.g., when a parking space is detected, when a parking space attribute is detected).

As also shown in FIG. 4A, at 420, in some implementations, process 400 may include using the detected parking spaces (e.g., detected parking spaces from the new set of detected parking spaces) to aid an activity associated with a vehicle. For example, a vehicle may request information about one or more parking spaces that are close in proximity to the vehicle. In some implementations, parking space detection server 200 or another server can provide one or more detected parking spaces and attributes associated with the detected parking spaces to the requesting vehicle. The vehicle can provide the parking space data to its advanced driverless assistance system to provide more accurate information about one or more parking spaces that can be used to aid in parking a vehicle (e.g., the boundaries of a parking space, what color is used for the parking space lines, whether the parking space has a curb, whether the parking space is restricted (e.g., handicapped, time limited, etc.). In some implementations, detected parking spaces can be used to inform governments how much parking is available in a particular area for urban planning. In some implementations, parking space detection server 200 can be used to provide information about detected parking spaces to inform entities of conditions of their assets (e.g., parking space lines are faded, surfaces of the parking spaces are in disrepair), which can be used to plan repairs and budget for future repairs. It should also be appreciated that, using the automated, more efficient, and more accurate parking space detection discussed herein, cities and towns can quickly determine parking spaces on a frequent basis, to deal with constantly changing in infrastructure.

Returning to FIG. 7, output 740 illustrates a parking lot with a plurality of parking spaces that were detected and tagged by parking space detection server 200. In some implementations, parking space detection server 200 may have also determined attributes associated with one or more of the detected parking spaces. As discussed above, the parking spaces shown as tagged in output 740 can be spaces initially identified by parking space detection server 200 as well as parking spaces that were detected using further processing, eliminating falsely detected parking spaces, parking spaces that were detected from synthesized tiles, and parking spaces that were detected despite being obscured from view.

Although FIG. 4A shows example blocks of process 400, in some implementations, process 400 may include additional blocks, fewer blocks, different blocks, or differently arranged blocks than those depicted in FIG. 4A. Additionally, or alternatively, two or more of the blocks of process 400 may be performed in parallel.

In some implementations, process 400 may include additional implementations, such as any single implementation or any combination of implementations described below and/or in connection with one or more other processes described elsewhere herein.

In a first implementation, the image tile may include a portion of a satellite image.

A second implementation, alone or in combination with the first implementation, process 400 further may include analyzing a plurality of image tiles for parking spaces.

A third implementation, alone or in combination with the first and second implementation, an image tile of the plurality of image tiles may include a portion of a satellite image.

A fourth implementation, alone or in combination with one or more of the first through third implementations, process 400 may include creating at least one synthetic image tile from at least two image tiles of the plurality of image tiles.

A fifth implementation, alone or in combination with one or more of the first through fourth implementations, process 400 may include detecting at least one new or previously undetected parking space from the at least one synthetic image tile.

In a sixth implementation, alone or in combination with one or more of the first through fifth implementations, at least a first portion of the detected at least one parking space from the at least one synthetic image tile was located on a first image tile of the at least two image tiles and at least a second portion of the detected at least one parking space from the at least one synthetic image tile was located on a second image tile of the at least two image tiles.

A seventh implementation, alone or in combination with one or more of the first through sixth implementations, process 400 further includes removing any detected false parking spaces from the detected at least one parking space from the at least one synthetic image tile; determining one or more parking space attributes from the detected at least one parking space from the at least one synthetic image tile; analyzing the synthetic image tile for additional obscured parking spaces based on the remaining plurality of parking spaces and the detected at least one parking space from the at least one synthetic image tile; determining at least one additional obscured parking space based on the remaining plurality of parking spaces and the detected at least one parking space from the at least one synthetic image tile; determining one or more parking space attributes of the at least one additional obscured parking space based on attributes determined from at least some of the remaining plurality of parking spaces and the detected at least one parking space from the at least one synthetic image tile; storing the remaining plurality of parking spaces, the determined at least one obscured parking space, the detected at least one parking space from the at least one synthetic image tile, the determined at least one obscured parking space, and their respective associated parking space attributes.

In an eighth implementation, alone or in combination with one or more of the first through seventh implementations, process 400 further includes comparing determined parking space attributes between an original image tile an at least a first synthetic image tile to determine discrepancies between the parking space attributes; and resolving at least one attribute discrepancies in the original image tile based a parking space attribute determined in the first synthetic image tile.

In an ninth implementation, alone or in combination with one or more of the first through eighth implementations, the activity associated with the vehicle is a commercial transaction. In some implementations, the commercial transaction may include automating a transaction to pay for energy for the vehicle (e.g., automatically activating a fuel pump or charging station and automatically paying for the fuel or electricity), automating a transaction for curb side delivery, automating a transaction for parking.

In a tenth implementation, alone or in combination with one or more of the first through ninth implementations, the activity associated with the vehicle is analyzing the vehicle's position for a geofencing system.

In a eleventh implementation, alone or in combination with one or more of the first through tenth implementations, the activity associated with the vehicle is navigation.

In an twelfth implementation, alone or in combination with one or more of the first through eleventh implementations, the activity associated with the vehicle is parking.

A thirteenth implementation, alone or in combination with one or more of the first through twelfth implementations, process 400 further may include obtaining one or more satellite images; creating a plurality of image tiles from the one or more satellite images; detecting a plurality of parking spaces from the plurality of image tiles.

In a fourteenth implementation, alone or in combination with one or more of the first through thirteenth implementations, the one or more parking space attributes may include line color and type of parking space.

In a fifteenth implementation, alone or in combination with one or more of the first through fourteenth implementations, the process 400 may include detecting at least duplicate parking space; and removing the detected at least one duplicate parking space.

In a sixteenth implementation, alone or in combination with one or more of the first through fifteenth implementations, the process 400 may include image analysis optimization. In some implementations, for example, parking space detection server 200 can be provided with GIS data identifying known parking lots and garages. In some implementations, parking space detection server 200 can restrict processing image tiles with coordinate data matching known parking lots and garages for parking spaces. In some implementations, this would reduce the amount of image tiles that are processed by parking space detection server 200, creating a more efficient parking space image processing system. In some implementations, parking space detection server 200 can be configured to first detect parking lots and parking garages using lower resolution satellite images (e.g., zoomed out satellite images, which allows more area to be analyzed with less image data). In some implementations, once parking lots and parking garages are detected, parking space detection server 200 can process image tiles with coordinates that match the coordinates of detected parking lots and parking garages to detect parking spaces using fewer higher resolution/zoom in images and image tiles. The foregoing optimization results in a more efficient computer system for detecting parking spaces because lower resolution image files can be used for a larger area of analysis, requiring less processing power and memory to process. Also processing fewer high resolution image tiles that can be limited to known coordinates with parking spaces, such as parking lots and parking garages, also results in a more efficient computer system for detecting parking spaces because processing fewer image tiles requires less processing power and memory to obtain detected parking spaces. In one example of processing parking spaces for a small city, such as Kobe, Japan, the process to detect parking spaces took 4 hours to process all or substantially all image tiles created from satellite images of Kobe, Japan. Using the more efficient processing noted above to reduce image size (lower resolution images covering larger geographical areas) and reduce the quantity of image tiles to process, cut down the processing time to detect parking space for the city of Kobe, Japan to approximately 1 hour. Similarly, processing can be further reduced by determining image tiles areas that contain a large quantity of water, forests, stadiums, large buildings, etc. enables parking space detection server 200 to avoid processing such image tiles, which also creates a faster and more efficient way to detect parking spaces in a given area.

In a seventeenth implementation, alone or in combination with one or more of the first through sixteenth implementations, in some aspects, the techniques described herein relate to a system including a processor, and a storage medium storing instructions, which when executed by the processor, causes the system to carry out the method of any one of the first through the sixteenth implementations.

In an eighteenth implementation, alone or in combination with one or more of the first through seventeenth implementations, in some aspects, the techniques described herein relate to a machine-readable medium carrying machine readable instructions, which when executed by a processor of a machine, causes the machine to carry out the method of any one of the first through the seventeenth implementations.

FIG. 4B is a flowchart of an example process of image preprocessing and determining one or more features/attributes based on the image preprocessing, according to some implementations of the present disclosure. As noted above in connection with 416 of FIG. 4A, parking space detection server 200 may perform image preprocessing on detected parking spaces to generate one or more additional images, such as the images shown in FIG. 8. In some implementations, one or more of these images can be created by manipulating a detected parking space, such as, but not limited to, highlighting and/or altering an aspect of the detected parking space. In some implementations, the generated manipulated image of the detected parking space can aid in detecting features/attributes of the detected parking space. In some implementations, one or more process blocks of FIG. 4B may be performed by a device, such as parking space detection server 200, some other suitable device, or a combination of devices. In some implementations, parking space detection module 220 of parking space detection server 200 may perform process 416. In some implementations, the process 416 can be performed by other modules, such as parking space detection module 210 or other suitable modules.

As shown in FIG. 4B, at 442, in some implementations, process 416 may include generating one or more new images using one or more different image manipulation/conversion process for at least one detected parking space. For example, as noted above, FIG. 8 illustrates detected parking space 810. FIG. 8 also illustrates a few generated images such as image 815 and image 820 that accentuate certain aspects of detected parking space 810. In some implementations, as shown at 444, parking space detection server 200 may analyze the one or more new images (e.g., image 815, image 820, etc.) using one or more different ML processes. In some implementations, parking space detection server 200 may analyze the new images using rule based algorithms. It should be appreciated that one or more of the ML processes and/or rule based algorithms can be configured to analyze a particular one of the new images. For example, an ML process may be configured to analyze generated images like image 820 to determine the boundaries of a detected parking space. In some implementations, as shown at 446, parking space detection server 200 may determine one or more parking space attributes based on the one or more different ML processes and/or rule based algorithms for at least one of the detected parking spaces. In some implementations, process 416 can be repeated for one or more detected parking spaces.

Although FIG. 4B shows example blocks of process 416, in some implementations, process 416 may include additional blocks, fewer blocks, different blocks, or differently arranged blocks than those depicted in FIG. 4B. Additionally, or alternatively, two or more of the blocks of process 416 may be performed in parallel.

Implementations described herein may be implemented in hardware, firmware, software, or any combination thereof. Implementations of the disclosure herein may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); hardware memory in handheld computers, smart phones, and other portable devices; magnetic disk storage media; optical storage media; USB drives and other flash memory devices; Internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

Although method/process operations (e.g., blocks) may be described in a specific order, it should be understood that other housekeeping operations can be performed in between operations, or operations can be adjusted so that they occur at different times or can be distributed in a system which allows the occurrence of the processing operations at various intervals associated with the processing, as long as the processing of the overlay operations are performed in the desired way.

The foregoing disclosure provides illustration and description but is not intended to be exhaustive or to limit the implementations to the precise form disclosed. Modifications may be made in light of the above disclosure or may be acquired from practice of the implementations. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

A number of implementations of the invention have been described. Various modifications may be made without departing from the spirit and scope of the invention. For example, various forms of the flow charts shown above may be used, with steps re-ordered, added, or removed. Accordingly, other implementations are within the scope of the following claims.

What is claimed is:

1. A method of operating a parking space detection system comprising:
analyzing an image tile for parking spaces;
detecting a plurality of parking spaces from the image tile;
analyzing the plurality of parking spaces for false parking spaces;
removing at least one detected false parking space from the plurality of parking spaces to form a set of remaining plurality of parking spaces;
analyzing the image tile for obscured parking spaces based on the remaining plurality of parking spaces;
determining at least one obscured parking space based on the remaining plurality of parking spaces;
determining one or more parking space attributes of the remaining plurality of parking spaces and of the at least one obscured parking space based on attributes determined from at least some of the remaining plurality of parking spaces;
storing the remaining plurality of parking spaces, the determined at least one obscured parking space, and their respective associated parking space attributes; and
enabling at least one detected parking space of the plurality of parking spaces to be used to aid an activity associated with a vehicle.

2. The method of operating the parking space detection system of claim 1, wherein the image tile comprises a portion of a satellite image.

3. The method of operating the parking space detection system of claim 1, further comprises analyzing a plurality of image tiles for parking spaces.

4. The method of operating the parking space detection system of claim 3, wherein an image tile of the plurality of image tiles comprises a portion of a satellite image.

5. The method of operating the parking space detection system of claim 3, further comprising creating at least one synthetic image tile from at least two image tiles of the plurality of image tiles.

6. The method of operating the parking space detection system of claim 5, further comprising detecting at least one parking space from the at least one synthetic image tile.

7. The method of operating the parking space detection system of claim 6, wherein at least a first portion of the detected at least one parking space from the at least one synthetic image tile was located on a first image tile of the at least two image tiles and at least a second portion of the detected at least one parking space from the at least one synthetic image tile was located on a second image tile of the at least two image tiles.

8. The method of operating the parking space detection system of claim 6, further comprising:
removing any detected false parking spaces from the detected at least one parking space from the at least one synthetic image tile;
determining one or more parking space attributes from the detected at least one parking space from the at least one synthetic image tile;
analyzing the synthetic image tile for additional obscured parking spaces based on the remaining plurality of parking spaces and the detected at least one parking space from the at least one synthetic image tile;
determining at least one additional obscured parking space based on the remaining plurality of parking spaces and the detected at least one parking space from the at least one synthetic image tile;
determining one or more parking space attributes of the at least one additional obscured parking space based on attributes determined from at least some of the remaining plurality of parking spaces and the detected at least one parking space from the at least one synthetic image tile; and
storing the remaining plurality of parking spaces, the determined at least one obscured parking space, the detected at least one parking space from the at least one synthetic image tile, the determined at least one obscured parking space, and their respective associated parking space attributes.

9. The method of operating the parking space detection system of claim 1, wherein the activity associated with the vehicle is a commercial transaction.

10. The method of operating the parking space detection system of claim 1, wherein the activity associated with the vehicle is analyzing the vehicle's position for a geofencing system.

11. The method of operating the parking space detection system of claim 1, wherein the activity associated with the vehicle is navigation.

12. The method of operating the parking space detection system of claim 1, wherein the activity associated with the vehicle is parking.

13. The method of operating the parking space detection system of claim 1, further comprises:
obtaining one or more satellite images;
creating a plurality of image tiles from the one or more satellite images; and
detecting a plurality of parking spaces from the plurality of image tiles.

14. The method of operating the parking space detection system of claim 1, wherein the one or more parking space attributes comprise line color and type of parking space.

15. A device for operating a parking space detection comprising:
one or more processors configured to:
analyze an image tile for parking spaces;
detect a plurality of parking spaces from the image tile;
analyze the plurality of parking spaces for false parking spaces;
remove at least one detected false parking space from the plurality of parking spaces to form a set of remaining plurality of parking spaces;
analyze the image tile for obscured parking spaces based on the remaining plurality of parking spaces;
determine at least one obscured parking space based on the remaining plurality of parking spaces;
determine one or more parking space attributes of the remaining plurality of parking spaces and one or more parking space attributes of the at least one obscured parking space based on attributes determined from at least some of the remaining plurality of parking spaces; and
store the remaining plurality of parking spaces, the determined at least one obscured parking space, and their respective associated parking space attributes.

16. The device of claim 15, wherein the image tile comprises a portion of a satellite image.

17. The device of claim 15, wherein the one or more processors are further configured to:
analyze a plurality of image tiles for parking spaces.

18. The device of claim 17, wherein an image tile of the plurality of image tiles comprises a portion of a satellite image.

19. The device of claim 17, wherein the one or more processors are further configured to:
create at least one synthetic image tile from at least two image tiles of the plurality of image tiles.

20. The device of claim 19, wherein the one or more processors are further configured to:
detect at least one parking space from the at least one synthetic image tile.

21. The device of claim 20, wherein at least a first portion of the detected at least one parking space from the at least one synthetic image tile was located on a first image tile of the at least two image tiles and at least a second portion of the detected at least one parking space from the at least one synthetic image tile was located on a second image tile of the at least two image tiles.

22. The device of claim 20, wherein the one or more processors are further configured to:
remove any detected false parking spaces from the detected at least one parking space from the at least one synthetic image tile;
determine one or more parking space attributes from the detected at least one parking space from the at least one synthetic image tile;
analyze the synthetic image tile for additional obscured parking spaces based on the remaining plurality of parking spaces and the detected at least one parking space from the at least one synthetic image tile;
determine at least one additional obscured parking space based on the remaining plurality of parking spaces and the detected at least one parking space from the at least one synthetic image tile;
determine one or more parking space attributes of the at least one additional obscured parking space based on attributes determined from at least some of the remaining plurality of parking spaces and the detected at least one parking space from the at least one synthetic image tile; and
store the remaining plurality of parking spaces, the determined at least one obscured parking space, the detected at least one parking space from the at least one synthetic image tile, the determined at least one obscured parking space, and their respective associated parking space attributes.

23. The device of claim 15, wherein the one or more processors are further configured to: enable at least one detected parking space of the plurality of parking spaces to be used to aid an activity associated with a vehicle, wherein the activity associated with the vehicle is a commercial transaction.

24. The device of claim 15, wherein the one or more processors are further configured to: enable at least one detected parking space of the plurality of parking spaces to be used to aid an activity associated with a vehicle, wherein the activity associated with the vehicle is analyzing the vehicle's position for a geofencing system.

25. The device of claim 15, wherein the one or more processors are further configured to: enable at least one detected parking space of the plurality of parking spaces to be used to aid an activity associated with a vehicle, wherein the activity associated with the vehicle is navigation.

26. The device of claim 15, wherein the one or more processors are further configured to: enable at least one detected parking space of the plurality of parking spaces to be used to aid an activity associated with a vehicle, wherein the activity associated with the vehicle is parking.

27. The device of claim 15, wherein the one or more processors are further configured to:
obtain one or more satellite images;
create a plurality of image tiles from the one or more satellite images; and
detect a plurality of parking spaces from the plurality of image tiles.

28. The device of claim 15, wherein the one or more parking space attributes comprise line color and type of parking space.
